(19) United States
(12) Patent Application Publication
(10) Pub. No.: US 2009/0317580 A1
(43) Pub. Date: Dec. 24, 2009

(54) CONNECTION BETWEEN FLAT PARTS

(76) Inventor: Thomas Roiser, Mondsee (AT)

Correspondence Address: YOUNG & THOMPSON, 209 Madison Street, Suite 500, Alexandria, VA, 22314, US

(21) Appl. No.: 12/307,225

(22) PCT Filed: Mar. 15, 2007
(86) PCT No.: PCT/AT07/00126

§ 371 Date: Apr. 10, 2009

(30) Foreign Application Priority Data
Jul. 3, 2006 (AT) GM 515/2006

(51) Int. Cl. B32B 3/08

(52) U.S. Cl. 428/61

(57) ABSTRACT

A connection between two parts (1, 2) of laminar, elastic, plastic foam includes a gluing (5) in the region of the butt joint (6) between the narrow surfaces (3, 4) of the parts (1, 2) and longitudinal, elastic covering strips (7), which are fixed on one or both of the large surfaces (9) of the parts (1, 2) and, in particular, are fastened by gluing (8) and which cover the butt joint (6).

The invention relates to a connection between flat parts, as can be used for example in articles of clothing of elastic foam. These articles of clothing can be suits, gloves, protective hoods, shoes, ankle socks, and the like. Articles of clothing which are exposed to wetness in use, such as articles of clothing for divers, bicyclers, motorcyclists, skiers, water skiers, and surfers, are especially considered.

In the past, parts of articles of clothing which consist of elastic flat material, especially of elastic foams (neoprene suits) have been joined to one another in a complex manner by specially made seams in order to produce the article of clothing. One disadvantage of the known seams is that on the one hand they are not watertight and on the other hand do not have sufficient elasticity. In addition the seams, because they impart an appearance of bulk, constitute an interruption of the article of clothing and especially when it is an article of clothing which tightly adjoins the body (gloves and protective hoods) they cause pressure points on the body of the wearer of the article of clothing, therefore are unpleasant to wear.

The object of the invention is to make available a connection between flat parts of the initially named type which does not have the described disadvantages, and is especially comfortable to wear.

This object is achieved with a connection which has the features of claim 1.

Preferred and advantageous embodiments of the invention are the subject matter of the dependent claims.

Since in the invention there is not a seam in the classical sense in the region of the connection of the two flat parts, therefore a seam using threads and the like, comfort of wearing is improved and the seam is elastic, since there are no elements which inhibit the elasticity of the parts which are connected to one another.

In one embodiment the connection is made such that the two parts of a flat material, especially rubber-elastic foam material (for example, neoprene) are connected to one another at least only by way of part of their bordering narrow surfaces. This connection can take place by cementing, bonding, or a combination of the two measures. Heat-activatable cements are especially well suited.

In one development of the invention, it is provided that in the region of the junction which has been formed in this way and at which the two parts of the flat material are connected to one another, a cover strip which conceals the junction is attached on one or both sides.

In one embodiment it is provided that the cover strip which conceals the junction is elastic lengthwise.

Preferred connecting techniques of the cover strip to the flat material are cementing techniques, especially cementing with cements which can be activated by heat. Other cements which can be activated by supplying energy (ultrasound, infrared, and the like in high frequency) are also considered. The cover strip can be connected to the parts, concealing their junction, also by bonding.

In one special embodiment of the connection as claimed in the invention which is considered especially for gloves, but which can also be used for protective hoods, the parts of rubber-elastic synthetic foam are joined to one another by their being continuously connected to one another on their narrow surfaces over their entire height. On at least one side a cover strip is applied, the cover strip being attached by a heat-activated cement to the two parts, concealing their junction in which there is cementing.

The cover strip which is preferably used in the invention is preferably made to be elastic lengthwise, so that the connection between the two parts of the article of clothing, especially of the glove or the protective hood (these protective hoods are worn for example under crash helmets or the like) is likewise elastic.

In another embodiment of the connection as claimed in the invention, the two parts are built up in several layers. The parts have for example a base body of fleece, especially a natural wool fleece, resting on this base body a membrane which is watertight but which breathes, and resting on the membrane, a fabric, especially a synthetic fiber fabric.

In one embodiment of the connection as claimed in the invention which is structured as follows, the two parts are connected to one another.

In the junction between the narrow surfaces of parts which have at least two layers, cement is applied preferably exclusively in the region of one layer, for example the fabric layer, therefore extends only over one part of the height of the narrow surfaces of the two parts. Since the two parts are connected to one another in this way, especially resting on the fabric layer a cover strip is applied by the cover strip being cemented on or being bonded to the fabric. If a cementing technique is used here, cements which can be activated by supplying energy (heat and the like) are considered.

Other details and features of the invention will become apparent from the following description of preferred embodiments using the drawings.

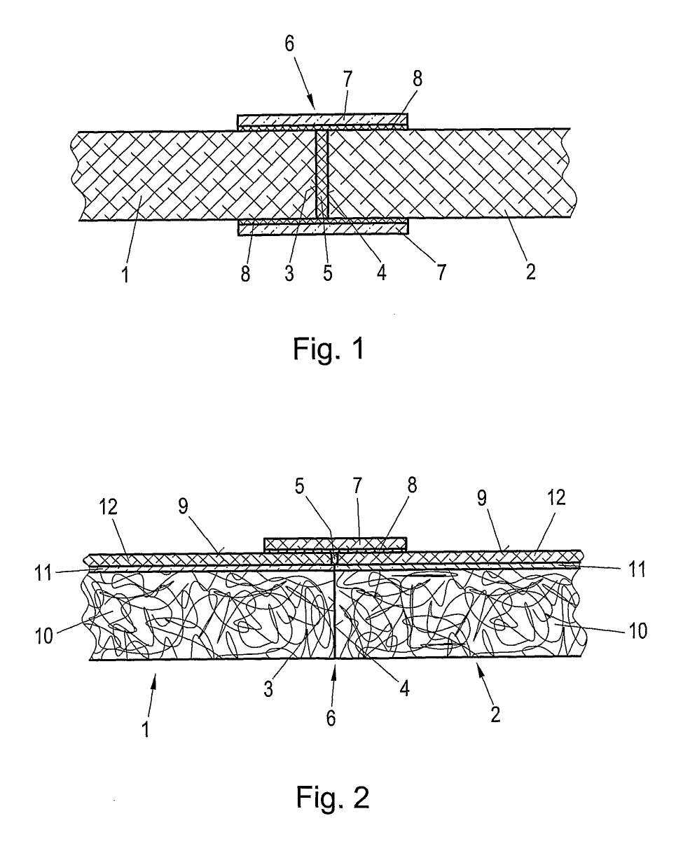

FIG. 1 shows a first embodiment in cross section (not to scale),

FIG. 2 shows another embodiment likewise in cross section and not to scale.

In the embodiment shown in FIG. 1, two parts 1, 2 of flat material, for example rubber-elastic foam, especially neoprene foam, are arranged lying next to one another with their narrow surfaces 3, 4, and are joined to one another with cementing 5 in the region between the narrow surfaces 3, 4. Here the cementing 5 extends over the entire height (width) of the narrow surfaces 3, 4 even if it is also considered that cementing 5 be provided only in one part of the height (width) of the narrow surfaces 3, 4 and/or cementing be provided not continuously over the length of the junction 6, but with interruptions.

On at least one side of the cemented junction 6 between parts 1 and 2 which has been produced in this way, a cover strip 7 is applied, its being provided that the cover strip 7 is provided with one layer 8 of heat activated cement. When the cover strip 7 is applied to the junction 6, between the two parts 1, 2 the cement of the layer 8 is activated and the cover strip 7 is pressed onto the large surfaces 9 of the parts 1, 2. The combined cementing technique achieves an elastic connection between the parts 1, 2 which essentially corresponds to the elasticity of the parts 1, 2 themselves.

In the embodiment shown in FIG. 2, the two parts 1, 2 are structured in several layers and have a base body 10 of fleece, especially a fleece of natural wool, for example merino wool, thereupon a layer 11 of watertight, but breathable material, especially a membrane, and resting on it, a layer 12 of fabric, for example a synthetic fiber fabric. The three aforementioned layers, therefore the fleece layer 10, the membrane 11 and the fabric 12, are connected to one another as is conventional in the prior art.

The two parts 1, 2 are joined to one another only in the region of the fabric layer 12 by a cement 5 which has been applied there. Bonding of the fabric layers by supplying heat is also considered, if the material of the fabric layers 12 allows this. As described above using FIG. 1, a cover strip 7 is applied to the junction 6 which has been produced in this way and in which the parts 1, 2 are joined to one another simply in the region of the fabric layers 12. Even if not shown, in the connection of FIG. 2 a second cover strip 7 can also be attached (cemented or bonded) on the fleece layer 10.

In summary, one embodiment of the invention can be described as follows:

A connection of two parts 1, 2 of flat, elastic synthetic foam comprises cementing 5 in the region of the junction 6 between the narrow surfaces 3, 4 of the parts 1, 2 and cover strips 7 which are elastic lengthwise, which conceal the junction 6, which are fastened especially by cementing 8, and which are attached on one or both large surfaces 9 of the parts 1, 2.

1. Connection for two flat parts (1, 2) which adjoin one another bluntly with at least one of their edge-side narrow surfaces (3, 4), characterized in that the flat parts (1, 2) in the region of their narrow surfaces (3, 4) in which the parts (1, 2) border one another are connected to one another (5) and that on at least one large surface (9) of the parts (1, 2) there is a cover strip (7) which conceals the interconnected edges of the parts (1, 2).

2. Connection as claimed in claim 1, wherein the narrow surfaces (3, 4) of the parts (1, 2) are connected to one another only over one part of their two-dimensional extension.

3. Connection as claimed in claim 2, wherein the narrow surfaces (3, 4) of the parts (1, 2) are connected to one another in several regions which are separated from one another and which are distributed over the length of the interconnected narrow surfaces (3, 4) of the parts (1, 2).

4. Connection as claimed in claim 2, wherein the narrow surfaces (3, 4) of the parts (1, 2) are connected to one another in at least one region which extends only over a fraction of the height (width) of the narrow surfaces (3, 4).

5. Connection as claimed in claim 1, wherein the narrow surfaces (3, 4) of the parts (1, 2) are cemented to one another.

6. Connection as claimed in claim 1, wherein the narrow surfaces (3, 4) of the parts (1, 2) are bonded to one another.

7. Connection as claimed in claim 1, wherein the cover strip (7) is cemented (8) to the large surface (9) of the two parts (1, 2).

8. Connection as claimed in claim 1, wherein the cover strip (7) is bonded to the large surface (9) of the two parts (1, 2).

9. Connection as claimed in claim 1, wherein the cover strip (7) is elastic at least in its lengthwise direction which extends in the direction of the junction (6) between the adjacent narrow surfaces (3, 4) of the parts (1, 2).

10. Connection as claimed in claim 1, wherein the parts (1, 2) consist of rubber-elastic foam plastic.

11. Connection as claimed in claim 1, wherein the parts (1, 2) consist of at least two layers of different materials.

12. Connection as claimed in claim 11, wherein the parts (1, 2) consist of a base layer (10) of fleece, a layer (11) of water-impermeable and/or breathable material, and a fabric layer (12).

13. Connection as claimed in claim 12, wherein the fleece is a fleece of natural fibers, especially merino wool.

14. Connection as claimed in claim 12, wherein the fabric layer (12) is a fabric layer of synthetic fibers.

15. Connection as claimed in claim 12, wherein the adjoining narrow surfaces (3, 4) of the parts (1, 2) are connected to one another (5) only in the region of one of their layers, especially of the fabric layer (12).

16. Connection as claimed in claim 12, wherein the cover strip (7) is located on the fabric layer (12).

17. Connection as claimed in claim 1, wherein the parts (1, 2) are cuttings for articles of clothing, especially for gloves, shoes, or protective hoods.

18. Connection as claimed in claim 1, wherein the cover strip is connected to the parts (1, 2) by a cement (8).

19. Connection as claimed in claim 18, wherein the cement is a cement (8) which can be activated by energy supply, especially heat or infrared or ultrasound.

20. Connection as claimed in claim 3, wherein the narrow surfaces (3, 4) of the parts (1, 2) are connected to one another in at least one region which extends only over a fraction of the height (width) of the narrow surfaces (3, 4).
